(19) United States
(12) Patent Application Publication
(10) Pub. No.: US 2024/0086510 A1
(43) Pub. Date: Mar. 14, 2024

(54) FACE AUTHENTICATION SYSTEM, FACE AUTHENTICATION METHOD, AND PROGRAM

(71) Applicant: NEC Corporation, Minato-ku, Tokyo (JP)

(72) Inventors: Makoto KATAOKA, Tokyo (JP); Yohel Itou, Tokyo (JP); Satoshi Terasawa, Tokyo (JP); Kazuki Seko, Tokyo (JP)

(73) Assignee: NEC Corporation, Minato-ku, Tokyo (JP)

(21) Appl. No.: 18/274,937

(22) PCT Filed: Jul. 16, 2021
(86) PCT No.: PCT/JP2021/026833

§ 371 Date: Jul. 28, 2023

(51) Int. Cl. G06F 21/32

(52) U.S. Cl. CPC G06F 21/32

(57) ABSTRACT

A first authentication apparatus executes authentication of a person captured in an input image by comparing face feature information of the person being acquired from an input image, with registered face feature information in a first watchlist. A second authentication apparatus executes authentication of a person unauthenticated with the first watchlist by comparing face feature information of the face feature information for which matching registered face feature information does not exist in the first watchlist, with registered face feature information in a second watchlist. A host server includes a watchlist updating unit that updates registered face feature information in the first watchlist and registered face feature information in the second watchlist, based on at least one of a priority degree for each piece of registered face feature information in the first watchlist and a priority degree for each piece of registered face feature information in the second watchlist.

### TECHNICAL FIELD

The present invention relates to an authentication technique using an image.

### BACKGROUND ART

One example of an authentication technique using an image is disclosed in Patent Documents 1 and 2 given below, for example.

Patent Document 1 discloses a technique of deciding, based on an image analysis result, presence of another person in a plurality of time ranges in proximity to a target person stored as a retrieval target in face information database, and performing pairing for such a person as a person relating to the target person. Further, Patent Document 2 discloses a technique of deciding an attribute, based on a feature of a face (face image) detected from image data, and transmitting retrieval information (face feature) to a retrieval server associated with the attribute being decided.

### RELATED DOCUMENT

### Patent Document

Patent Document 1: Japanese Patent Application Publication No. 2020-160581
Patent Document 2: Japanese Patent Application Publication No. 2012-252654

### SUMMARY OF INVENTION

### Technical Problem

In a video surveillance system, the number of false person detection cases by the system (false-negative identification-error rate: FNIR, false-positive identification-error rate: FPIR) is increased as the number of person candidates included in a list (hereinafter, also referred to as a “watchlist”) of person candidates to be discovered (authenticated) is increased. When the number of person candidates included in the watchlist is reduced, false detection can be suppressed, but the number of persons who cannot be detected by the system is increased. It is required to manage the watchlist in such a way as to be able to authenticate an appropriate person while maintaining recognition accuracy. The present invention has been made in view of the above-mentioned problem. One object of the present invention is to provide a technique for managing a watchlist in such a way as to be able to authenticate an appropriate person while maintaining recognition accuracy.

### Solution to Problem

A face authentication system according to the present disclosure includes: a first authentication apparatus that executes authentication of a person captured in an input image by comparing face feature information of the person being acquired from the input image, with registered face feature information in a first watchlist;

a second authentication apparatus that executes authentication of a person unauthenticated with the first watchlist by comparing face feature information of the face feature information for which matching registered face feature information does not exist in the first watchlist, with registered face feature information in a second watchlist; and a watchlist updating unit that updates registered face feature information in the first watchlist and registered face feature information in the second watchlist, based on at least one of a priority degree for each piece of registered face feature information in the first watchlist and a priority degree for each piece of registered face feature information in the second watchlist.

A face authentication method according to the present disclosure includes: by a first authentication apparatus, executing authentication of a person captured in an input image by comparing face feature information of the person being extracted from the input image, with registered face feature information in a first watchlist;
by a second authentication apparatus, executing authentication of a person unauthenticated with the first watchlist by comparing face feature information of the face feature information for which matching registered face feature information does not exist in the first watchlist, with registered face feature information in a second watchlist; and by a host server, updating registered face feature information in the first watchlist and registered face feature information in the second watchlist, based on at least one of a priority degree for each piece of registered face feature information in the first watchlist and a priority degree for each piece of registered face feature information in the second watchlist. A program according to the present disclosure causes a computer to function as:

a watchlist updating unit that updates registered face feature information in a first watchlist and registered face feature information in a second watchlist, based on at least one of a priority degree for each piece of registered face feature information in the first watchlist and a priority degree for each piece of registered face feature information in the second watchlist.

### Advantageous Effects of Invention

According to the present invention, it is possible to manage a watchlist in such a way as to be able to authenticate an appropriate person while maintaining recognition accuracy.

### BRIEF DESCRIPTION OF THE DRAWINGS

FIG. 1 It is a diagram illustrating a configuration of a face authentication system according to a first example embodiment.

FIG. 2 It is a diagram illustrating a specific example of a first watchlist.

FIG. 3 It is a diagram illustrating a specific example of a second watchlist.

FIG. 4 It is a diagram illustrating the first watchlist after information switching is executed.

FIG. 5 It is a diagram illustrating the second watchlist after information switching is executed.

FIG. 6 It is a diagram illustrating a hardware configuration of a first authentication apparatus.

FIG. 7 It is a diagram illustrating a hardware configuration of a second authentication apparatus.

FIG. 8 It is a diagram illustrating a hardware configuration of a host server.

FIG. 9 It is a flowchart illustrating a flow of processing executed by the first authentication apparatus of the first example embodiment.

FIG. 10 It is a flowchart illustrating a flow of processing executed by the second authentication apparatus of the first example embodiment.

FIG. 11 It is a flowchart illustrating one example of update processing for a priority degree of registered face feature information.

FIG. 12 It is a flowchart illustrating one example of update processing for a priority degree of registered face feature information.

FIG. 13 It is a flowchart illustrating one example of update processing for a priority degree of registered face feature information.

FIG. 14 It is a flowchart illustrating one example of update processing for a priority degree of registered face feature information.

FIG. 15 It is a flowchart illustrating update processing for a watchlist being executed by a watchlist updating unit.

FIG. 16 It is a diagram illustrating information indicating a correlation between the first authentication apparatus and attribute information.

FIG. 17 It is a diagram illustrating a configuration of a face authentication system of a second example embodiment.

FIG. 18 It is a flowchart illustrating a flow in which a watchlist updating unit of a third example embodiment transfers registered face profit information in a first watchlist to a second watchlist.

FIG. 19 It is a flowchart illustrating a flow in which the watchlist updating unit of the third example embodiment transfers registered face profit information in the second watchlist to the first watchlist.

FIG. 20 It is a flowchart illustrating a flow in which the watchlist updating unit of the third example embodiment transfers registered face profit information in the second watchlist to the first watchlist.

FIG. 21 It is a flowchart illustrating a flow in which the watchlist updating unit of the third example embodiment transfers registered face profit information in the first watchlist to the second watchlist.

### DESCRIPTION OF EMBODIMENTS

Example embodiments of the present invention are described below with reference to the drawings. Note that, in all the drawings, a similar constituent element is denoted with a similar reference sign, and description therefor is omitted as appropriate. Further, unless otherwise particularly described, each block in each of the block diagrams represents a configuration in a function unit instead of a configuration in a hardware unit. Further, a direction of an arrow in the drawings are for better understanding of a flow of information, and do not limit a direction of communication (unidirectional communication/bidirectional communication), unless otherwise particularly described.

### First Example Embodiment

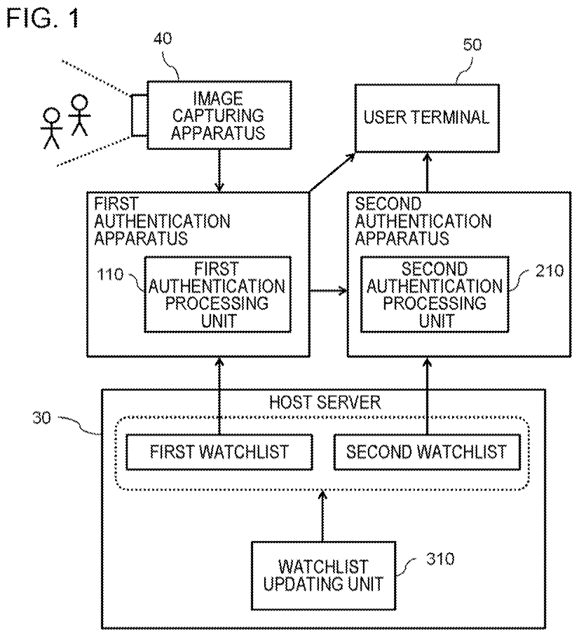

FIG. 1 is a diagram illustrating a configuration of a face authentication system according to a first example embodiment. In the example in the present drawing, a face authentication system 1 at least includes a first authentication apparatus 10, a second authentication apparatus 20, and a host server 30. Note that, in the present drawing, for sake of convenience of description, it is assumed that the face authentication system 1 includes one first authentication apparatus and one second authentication apparatus 20. The configuration of the face authentication system 1 is not limited to the example in FIG. 1. For example, the face authentication system 1 may be configured to include a plurality of the first authentication apparatuses 10. Further, the face authentication system 1 may be configured to include one second authentication apparatus 20 (or a plurality thereof, in view of processing distribution) with respect to a plurality of the first authentication apparatuses 10.

The first authentication apparatus 10 acquires, as an input image, an image (video) generated by an image capturing apparatus 40 connected to the face authentication system 1, and executes face authentication processing for a person captured in the input image. In the example of the drawing, the first authentication apparatus 10 includes a first authentication processing unit 110 that executes the face authentication processing. The first authentication processing unit 110 executes authentication of a person captured in an image generated by the image capturing apparatus 40, by using a watchlist stored in a storage region (a memory, a storage, or the like) of the first authentication apparatus 10. In the example of the drawing, the first authentication apparatus acquires the watchlist for the first authentication apparatus 10 from the host server 30, and stores the acquired watchlist in a predetermined storage region.

The watchlist includes face feature information (hereinafter, also referred to as “registered face feature information”) being registered in advance for each person being a target of face authentication using an image. Further, the watchlist further includes information (hereinafter, also referred to as “priority degree information”) indicating a priority degree, for each piece of the registered face feature information.

For example, the first authentication processing unit 110 is operated as described below. First, the first authentication processing unit 110 acquires, as an input image, an image generated by the image capturing apparatus 40 substantially in real time. Further, the first authentication processing unit 110 detects an image region (face region) of a face of a person from the input image, and acquires information (face feature information) indicating a feature of the face of the person for each of the face region of the person being detected. For example, the first authentication processing unit 110 may acquire the face region itself (partial image) being detected, as the face feature information, or may acquire various image feature values that can be extracted from the face region being detected, as the face feature information. Note that, in view of privacy, the latter information is preferred as the face feature information. The first authentication processing unit 110 executes authentication of a person captured in the input image by comparing the face feature information acquired from the input image with the registered face feature information in the watchlist stored in the first authentication apparatus 10. For example, when the registered face feature information that matches with certain face feature information acquired from the input image exists in the watchlist, the first authentication processing unit 110 is capable of authenticating a person associated with the registered face feature information as the person captured in the input image. Note that, “matching” in the present specification indicates that a similarity degree is equal to or more than a predetermined threshold value. In this case, there is a possibility that a plurality of pieces of the registered face feature information indicating the similarity degree being equal to or more than the predetermined threshold value exist in the watchlist. In such a case, for example, the first authentication processing unit 110 is capable of authenticating a person associated with the registered face feature information having the highest similarity degree, as the person captured in the input image. When a certain person is authenticated by using a first watchlist, the first authentication processing unit 110 notifies a user of information (a face photograph, a name, or the like being registered in advance) relating to the person via a user terminal 50 (for example, a smartphone, a tablet terminal, a stationary personal computer (PC), or the like).

Note that, when the registered face feature information associated with the face feature information acquired from the input image does not exist in the watchlist of the first authentication apparatus 10, a person associated with the face feature information is not authenticated. When such face feature information exists, the first authentication apparatus 10 transfers the face feature information to the second authentication apparatus 20.

The second authentication apparatus 20 executes additional face authentication processing for a person who is not authenticated by the face authentication processing using the watchlist stored in the first authentication apparatus 10. In the example of the drawing, the second authentication apparatus 20 includes a second authentication processing unit 210 that executes the face authentication processing. The second authentication processing unit 210 executes authentication of a person associated with the face feature information transmitted from the first authentication apparatus 10, by using a watchlist stored in a storage region (a memory, a storage, or the like) of the second authentication apparatus 20. In the example of the drawing, the second authentication apparatus 20 acquires the watchlist for the second authentication apparatus 20 from the host server 30, and stores the acquired watchlist in a predetermined storage region. The watchlist stored in the second authentication apparatus 20 is similar to the watchlist stored in the first authentication apparatus 10, except that information included therein is different. Note that, in the following description, the watchlist stored in the first authentication apparatus 10 is referred to as a “first watchlist”, and the watchlist stored in the second authentication apparatus 20 is referred to as a “second watchlist” for clear distinction between the two.

As one example, the first watchlist includes information relating to a person to be prioritized over a group of persons being an authentication target, and the second watchlist includes information relating to the other persons. Note that, the second watchlist may include at least part of the information included in the first watchlist in an overlapping manner. Herein, in view of maintaining authentication accuracy, the number of pieces of data (the registered face feature information) included in the first watchlist is provided with a predetermined upper limit value according to accuracy required for a system side. Thus, the number of pieces of the registered face feature information included in the second watchlist is basically more than the number of pieces of the registered face feature information included in the first watchlist.

Herein, the second authentication processing unit 210 may identify all the registered face features included in the second watchlist as a comparison target, or may limit a comparison target by using a priority degree of each piece of the registered face feature information in order to avoid increase in processing load. For example, at a time point when authentication for the number (example: n as an upper limit number of persons, m % of the total pieces of the registered face feature information included in the watchlist, or the like) of persons, which is set in advance by a user, is executed, the second authentication processing unit 210 may terminate the processing even though a piece of the registered face feature information before comparison remains in the second watchlist. Further, when additional information (attribute information such as age and gender) is included in the registered face feature information in the second watchlist, the second authentication processing unit 210 may execute, before executing the comparison processing, processing of estimating age or gender from the face feature information being received, and may select the registered face feature information having a common or similar attribute as a comparison target with priority.

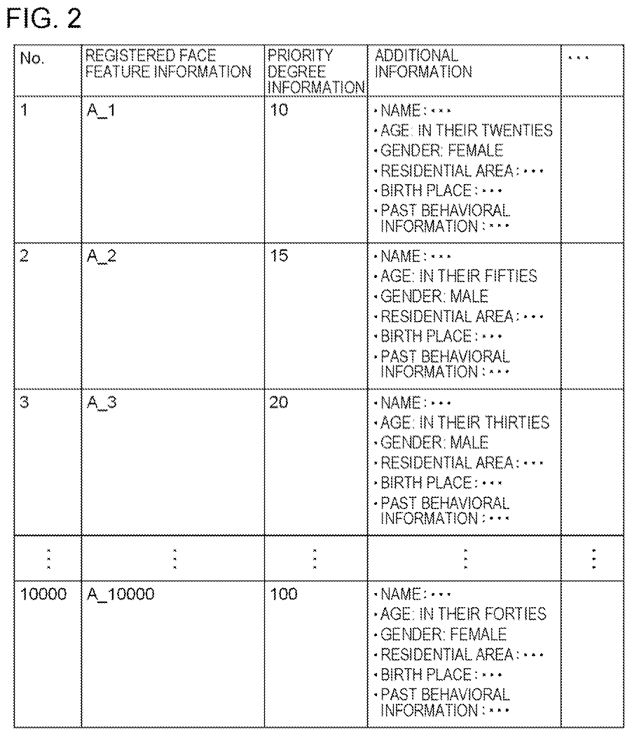

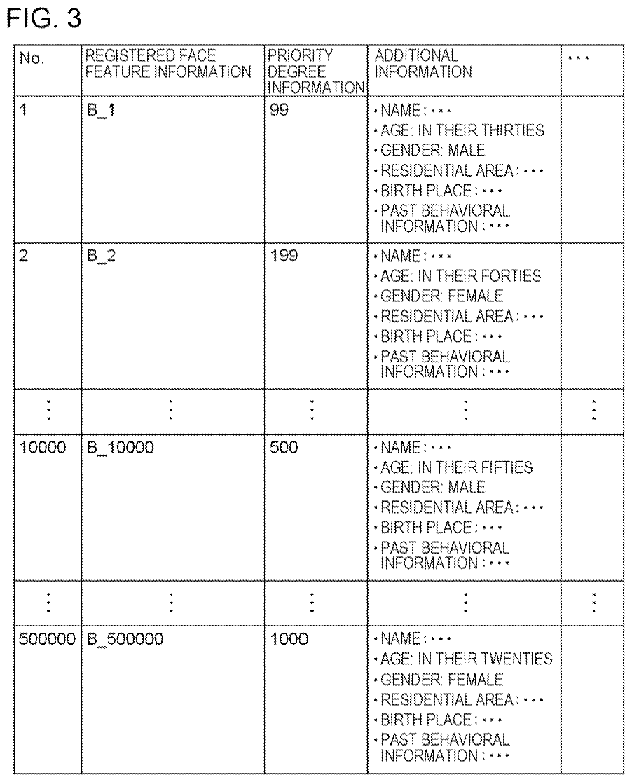

The host server 30 manages the first watchlist (example: FIG. 2) used in the first authentication apparatus 10 and the second watchlist (example: FIG. 3) used in the second authentication apparatus 20. FIG. 2 is a diagram illustrating a specific example of the first watchlist. FIG. 3 is a diagram illustrating a specific example of the second watchlist. As described above, the watchlist includes the registered face feature information and the priority degree information for each person being a target of face authentication using an image. The registered face feature information may be a face image captured in advance, various image feature values that can be extracted from the face image, or a combination thereof. The priority degree information is only required to be information that enables discrimination of the priority degree of each piece of the registered face feature information. In the example in the present drawing, the priority degree of each piece of the registered face feature information is indicated with a simple numerical value. Note that, in the example in the present drawing, as the value indicated with the priority degree information is smaller, the priority degree of the registered face feature information being associated is higher. Further, as illustrated in the drawing, the watchlist may further include information (additional information) including various attributes of a person associated with the registered face feature information. In the example of the drawing, the additional information is not particularly limited, and includes a name, age, gender, a residential area, a birth place, and past behavioral information.

Further, the host server 30 further includes a watchlist updating unit 310. The watchlist updating unit 310 updates the priority degree of each of the registered face feature information in the first watchlist and the registered face feature information in the second watchlist, according to a predetermined trigger. A specific example of processing of updating the priority degree of the registered face feature information will be described later. Further, the watchlist updating unit 310 updates the registered face feature information in the first watchlist and the registered face feature information in the second watchlist, based on the priority degree for each piece of the registered face feature information in the first watchlist and the priority degree for each piece of the registered face feature information in the second watchlist.

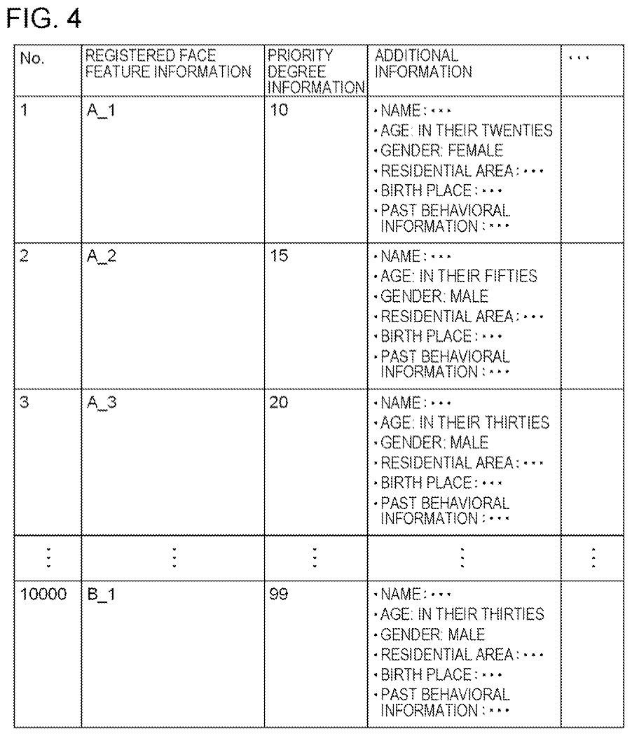

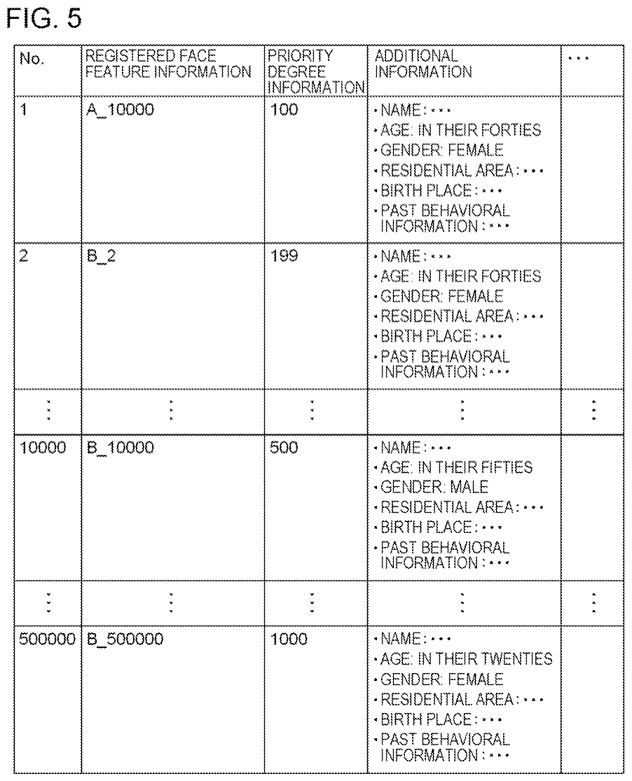

As one example, when a priority degree of certain registered face feature information in the second watchlist exceeds a priority degree of certain registered face feature information in the first watchlist due to at least any one of a change of the priority degree of the registered face feature information in the first watchlist and a change of the priority degree of the registered face feature information in the second watchlist, the watchlist updating unit 310 is capable of switching those pieces of the registered face feature information. For example, in a state in FIGS. 2 and 3, a priority degree of registered face feature information associated with “No. 10000” in the first watchlist is “100”, and a priority degree of registered face feature information associated with “No. 1” in the second watchlist is “99”. In this case, the priority degree of the registered face feature information associated with “No. 1” in the second watchlist is higher than the priority degree of the registered face feature information associated with “No. 10000” in the first watchlist. In such a case, the watchlist updating unit 310 executes switching of information as illustrated in FIGS. 4 and 5. FIG. 4 is a diagram illustrating the first watchlist after information switching is executed. FIG. 5 is a diagram illustrating the second watchlist after information switching is executed. In the example of the drawings, information stored in the column of “No. 1” in the second watchlist is transferred to the first watchlist, and information stored in the column of “No. 10000” in the first watchlist is transferred to the second watchlist. The watchlist updating unit 310 transmits each of the first watchlist and the second watchlist after the information is switched to each of the first authentication apparatus 10 and the second authentication apparatus 20. Note that, switching of the information can be achieved by another method. For example, in a conceivable method, the first watchlist and the second watchlist are provided with flag information for switching validity/invalidity for each piece of the registered face feature information. In this case, the watchlist updating unit 310 is capable of switching a substantial content in each watchlist by switching a set value of the flag information for each piece of the registered face feature information in each watchlist.

### <Hardware Configuration Example>

Each of functional constituent units of each of the apparatuses (the first authentication apparatus 10, the second authentication apparatus 20, and the host server 30) included in the face authentication system 1 may be achieved by hardware (example: a hard-wired electronic circuit) for achieving each of the functional constituent units, or may be achieved by a combination of hardware and software (example: a combination of an electronic circuit and a program for controlling the same). Description is further made below on a case in which each of the functional constituent units of each of the apparatuses is achieved by a combination of hardware and software.

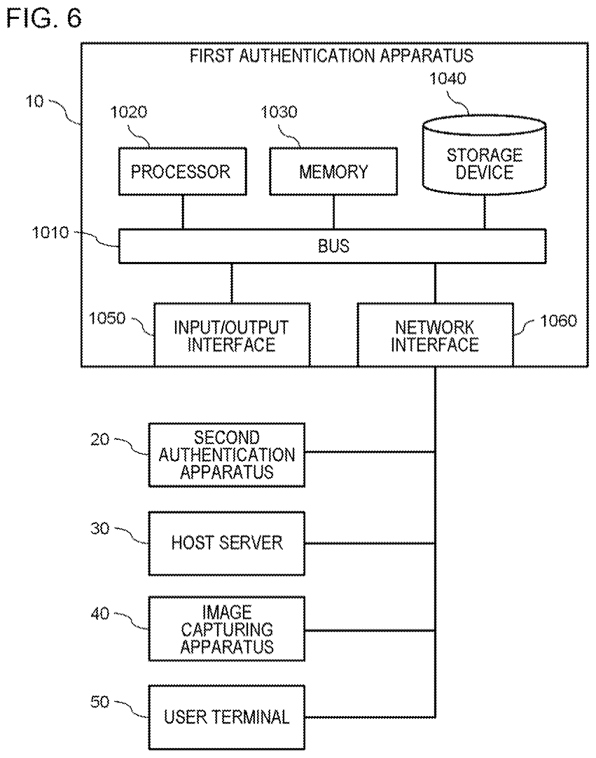

FIG. 6 is a diagram illustrating a hardware configuration of the first authentication apparatus 10. The first authentication apparatus 10 includes a bus 1010, a processor 1020, a memory 1030, a storage device 1040, an input/output interface 1050, and a network interface 1060.

The bus 1010 is a data transmission path in which the processor 1020, the memory 1030, the storage device 1040, the input/output interface 1050, and the network interface 1060 transmit and receive data mutually. However, a method of connecting the processor 1020 and the like to one another is not limited to bus connection. The processor 1020 is a central processing unit (CPU), a graphics processing unit (GPU), or the like.

The memory 1030 is a main storage apparatus such as a random access memory (RAM).

The storage device 1040 is an auxiliary storage apparatus such as a hard disk drive (HDD), a solid state drive (SSD), a memory card, or a read only memory (ROM). The storage device 1040 stores a program module for achieving each of the functions (the first authentication processing unit 110 and the like) of the first authentication apparatus 10. The processor 1020 reads each of the program modules on the memory 1030 and executes the program module, and thereby each of the functions associated with each of the program modules is achieved. Further, the storage device 1040 may be utilized as a storage region that stores the first watchlist acquired from the host server 30.

The input/output interface 1050 is an interface for connecting the first authentication apparatus 10 to various input/output devices. For example, an input device such as a mouse, a keyboard, and a touch panel, an output device such as a display and a speaker, and the like may be connected to the input/output interface 1050.

The network interface 1060 is an interface for connecting the first authentication apparatus 10 to a network, and communicating with other apparatuses (the second authentication apparatus 20, the host server 30, the image capturing apparatus 40, the user terminal 50, and the like) on the network. For example, the network is a local area network (LAN) or a wide area network (WAN). Wireless connection or wired connection may be adopted as a method by which the network interface 1060 is connected to the network. Note that, the hardware configuration illustrated in FIG. 6 is merely one example. The hardware configuration of the first authentication apparatus 10 according to the present disclosure is not limited to the example in FIG. 6.

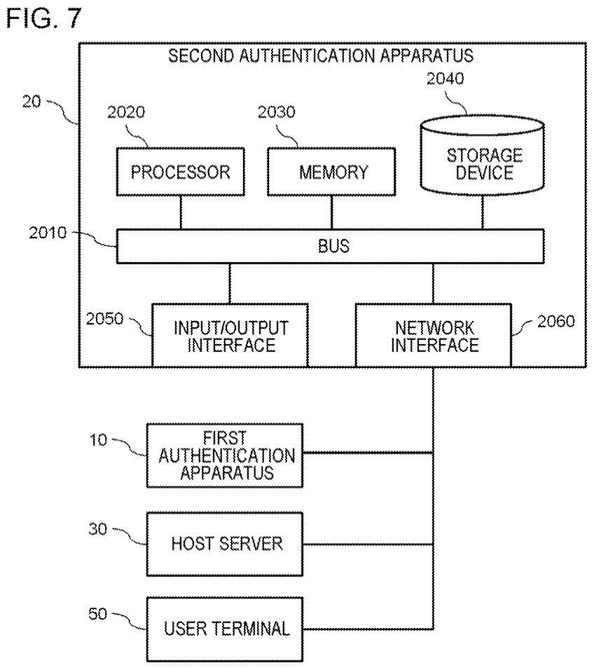

FIG. 7 is a diagram illustrating a hardware configuration of the second authentication apparatus 20. The illustrated hardware configuration of the second authentication apparatus 20 is substantially similar to the hardware configuration of the first authentication apparatus 10. An overlapping point described in the hardware configuration example of the first authentication apparatus 10 is omitted.

A storage device 2040 stores a program module for achieving each of functions (the second authentication processing unit 210 and the like) of the second authentication apparatus 20. A processor 2020 reads each of the program modules on a memory 2030 and executes the program module, and thereby each of the functions associated with each of the program modules is achieved. Further, the storage device 2040 may be utilized as a storage region that stores the second watchlist acquired from the host server 30.

In the example in the present drawing, the second authentication apparatus 20 communicates with other apparatuses (the first authentication apparatus 10, the host server 30, the user terminal 50, and the like) on a network via a network interface 2060.

Note that, the hardware configuration illustrated in FIG. 7 is merely one example. The hardware configuration of the second authentication apparatus 20 according to the present disclosure is not limited to the example in FIG. 7.

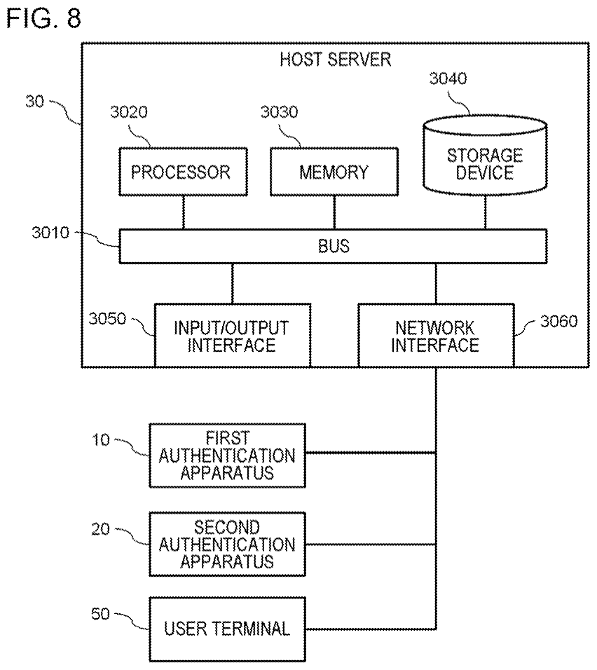

FIG. 8 is a diagram illustrating a hardware configuration of the host server 30. The illustrated hardware configuration of the host server 30 is substantially similar to the hardware configurations of the first authentication apparatus 10 and the second authentication apparatus 20. An overlapping point described in the hardware configuration examples of the first authentication apparatus 10 and the second authentication apparatus 20 is omitted. A storage device 3040 stores a program module achieving each of functions (the watchlist updating unit 310 and the like) of the host server 30. A processor 3020 reads each of the program modules on a memory 3030 and executes the program module, and thereby each of the functions associated with each of the program modules is achieved. Further, the storage device 3040 may be utilized as a storage region that stores data in the first watchlist for the first authentication apparatus 10 and data in the second watchlist for the second authentication apparatus 20.

In the example in the present drawing, the host server 30 communicates with other apparatuses (the first authentication apparatus 10, the second authentication apparatus 20, the user terminal 50, and the like) on a network via a network interface 3060. For example, as described below, the host server 30 is capable of receiving feedback information from the first authentication apparatus and the second authentication apparatus 20 via the network interface 3060. Further, in some case, the host server 30 is configured to accumulate, in a storage region such as the storage device 3040, a result of the authentication processing executed by the first authentication apparatus 10 and the second authentication apparatus 20. In this case, the host server 30 is also capable of receiving a request for referring to a result (a history of the authentication processing) of the authentication processing in a past from the user terminal 50 via the network interface 3060. In this case, the host server 30 is capable of transmitting the result of the authentication processing in the past being associated with the request, toward the user terminal 50 via the network interface 3060. Note that, the hardware configuration illustrated in FIG. 8 is merely one example. The hardware configuration of the host server 30 according to the present disclosure is not limited to the example in FIG. 8.

### <Flow of Authentication Processing>

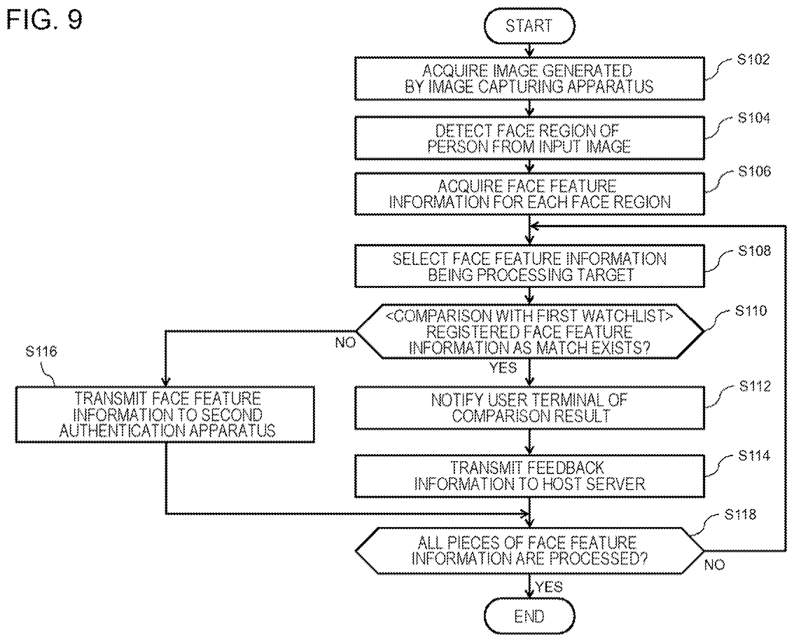

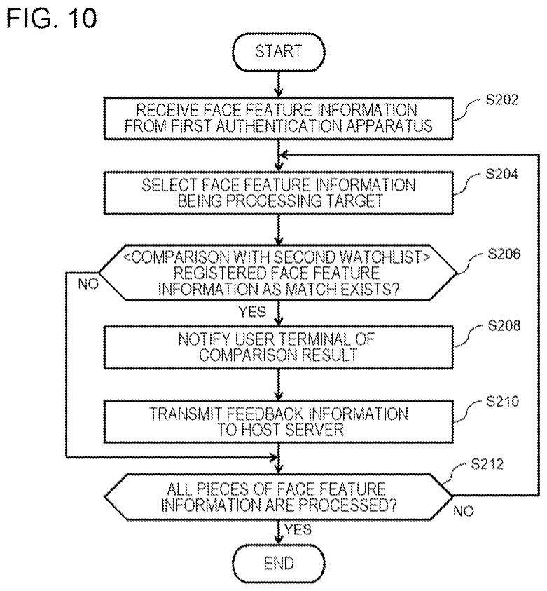

With reference to FIGS. 9 and 10, a flow of the authentication processing executed by the face authentication system 1 of the first example embodiment is described. FIG. 9 is a flowchart illustrating a flow of processing executed by the first authentication apparatus 10 of the first example embodiment. FIG. 10 is a flowchart illustrating a flow of processing executed by the second authentication apparatus 20 of the first example embodiment.

First, with reference to FIG. 9, the processing of the first authentication apparatus 10 is described. The first authentication processing unit 110 acquires an image (video) generated by the image capturing apparatus 40 as an input image (S102). When the input image is acquired from the image capturing apparatus 40, the first authentication processing unit 110 detects an image region (face region) associated with a face of a person from the image (S104). The first authentication processing unit 110 is capable of detecting a face of a person from the input image by utilizing an existing face detection algorithm, for example.

Subsequently, the first authentication processing unit 110 acquires face feature information for each of the face regions being detected (S106). For example, the first authentication processing unit 110 may extract a face region (partial image) being detected, as the face feature information, from the input image, or may acquire various image feature values that can be extracted from the face region.

Subsequently, the first authentication processing unit 110 selects, from the face feature information acquired for each of the face regions by the processing in S106, face feature information being a processing target (S108), and performs comparison with registered face feature information in the first watchlist (S110). For example, for each piece of the registered face feature information in the first watchlist, the first authentication processing unit 110 computes a similarity degree with the face feature information acquired from the face region being a target. Subsequently, the first authentication processing unit 110 decides whether the registered face feature information matching therewith (the similarity degree is equal to or more than a predetermined threshold value) exists, based on the similarity degree computed for each piece of the registered face feature information in the first watchlist.

When the registered face feature information that matches with face feature value information relating to the input image exists in the first watchlist (S110: YES), the first authentication processing unit 110 notifies the user terminal 50 of information relating to a person associated with the registered face feature information (S112). For example, the first authentication processing unit 110 notifies the user terminal 50 of the registered face feature information (specifically, a face photograph) being decided as a match, additional information (a name and age) of the person associated with the registered face feature information, and the like.

Further, at this time, the first authentication processing unit 110 may perform feedback an actual comparison result (information indicating the registered face feature information being matched in a current comparison) to the host server 30 (S114). When feedback information is received from the first authentication processing unit 110, the host server 30 updates a priority degree of the registered face feature information in the first watchlist, based on the feedback information. Processing of updating the priority degree is described later.

On the other hand, when the registered face feature information that matches with the face feature value information extracted from the input image does not exist in the first watchlist (S110: NO), the first authentication processing unit 110 transmits the face feature information to the second authentication apparatus 20 (S116). At this time, the first authentication processing unit 110 may transmit the face feature information in association with various types of additional information. For example, the additional information includes, but is not particularly limited to, information indicating a time when the input image is captured, information for discriminating a camera that captures the input image, information indicating a location where the input image is captured, and the like.

The first authentication processing unit 110 repeats the processing from S108 until all pieces of the face feature information acquired from the input image are subjected to the processing (S118).

Next, with reference to FIG. 10, the processing of the second authentication apparatus 20 is described.

First, the second authentication processing unit 210 receives face feature information from the first authentication apparatus 10 (S202). Subsequently, the second authentication processing unit 210 selects, from the face feature information received from the first authentication apparatus 10, face feature information being a processing target (S204), and performs comparison with registered face feature information in the second watchlist (S206). For example, for each piece of the registered face feature information in the second watchlist, the second authentication processing unit 210 computes a similarity degree with the face feature information acquired from a face region being a target. Subsequently, the second authentication processing unit 210 decides whether the registered face feature information matching therewith (the similarity degree is equal to or more than a predetermined threshold value) exists, based on the similarity degree computed for each piece of the registered face feature information in the second watchlist.

When the registered face feature information that matches with the face feature value information acquired from the first authentication apparatus 10 exists in the second watchlist (S206: YES), the second authentication processing unit 210 notifies the user terminal 50 of information relating to a person associated with the registered face feature information (S208). For example, the second authentication processing unit 210 notifies the user terminal 50 of the registered face feature information (specifically, a face photograph) being decided as a match, the additional information (a name and age) of the person associated with the registered face feature information, and the like.

Further, at this time, similarly to the first authentication processing unit 110, the second authentication processing unit 210 may perform feedback an actual comparison result (information indicating the registered face feature information being matched in a current comparison) to the host server 30 (S210). When feedback information is received from the second authentication processing unit 210, the host server 30 updates a priority degree of the registered face feature information in the second watchlist, based on the feedback information. Processing of updating the priority degree is described later. On the other hand, when the registered face feature information that matches with the face feature value information extracted from the input image does not exist in the second watchlist (S206: NO), the processing proceeds to S212.

The second authentication processing unit 210 repeats the processing from S204 until all pieces of the face feature information received from the first authentication apparatus 10 are subjected to the processing (S210). Herein, for example, the second authentication processing unit 210 may be configured to execute comparison in order of the priority degree, based on the priority degree of the registered face feature information in the second watchlist and terminate the processing in a phase in which the pre-set number of persons is detected through by comparison. Further, for example, in place of the priority degree indicated in the priority degree information, the second authentication processing unit 210 may execute comparison in order of registration, based on an information registration date. Further, for example, the second authentication processing unit 210 may acquire attribute information such as gender and age by executing gender estimation processing or age estimation processing before executing comparison, and execute comparison in order from a higher matching degree between the attribute information being acquired and the additional information in the second watchlist.

<Update Processing for Priority Degree of Registered Face Feature Information>

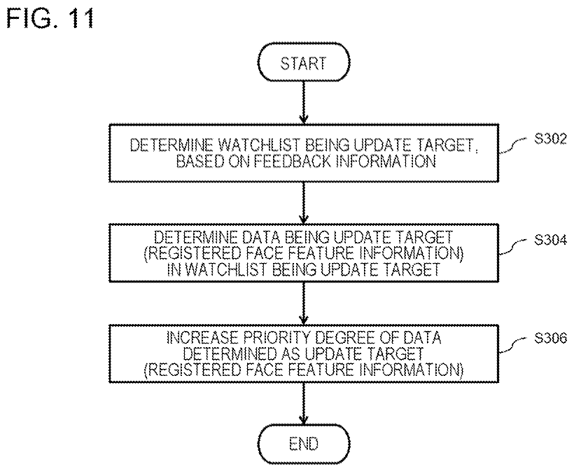

With reference to FIGS. 11 to 14, description is made on how the priority degree of the registered face feature information in the watchlist is updated.

<<Update Processing 1>>

FIG. 11 is a flowchart illustrating one example of update processing for the priority degree of the registered face feature information. The update processing in the present drawing is processing of changing the priority degree, based on the feedback information (actual comparison result) transmitted from the first authentication processing unit 110 and the second authentication processing unit 210 as illustrated in FIGS. 9 and 10.

The watchlist updating unit 310 determines the watchlist being an update target, based on the feedback information being acquired (S302). For example, the watchlist updating unit 310 is capable of determining the watchlist being an update target, based on information indicating a transmission source of the feedback information. Specifically, when the feedback information is transmitted from the first authentication apparatus 10 (the first authentication processing unit 110), the watchlist updating unit 310 is capable of determining the first watchlist as an update target. Further, when the feedback information is transmitted from the second authentication apparatus 20 (the second authentication processing unit 210), the watchlist updating unit 310 is capable of determining the second watchlist as an update target.

Subsequently, the watchlist updating unit 310 determines target data (the registered face feature information) including a priority degree to be updated in the watchlist determined in S302 (S304). For example, the watchlist updating unit 310 is capable of determining target data, based on the actual comparison result (information indicating the registered face feature information being compared) included in the feedback information.

Subsequently, the watchlist updating unit 310 increases the priority degree of the target data determined by the processing in S304 (S306). For example, when the priority degree becomes higher as a value indicated in the priority degree information is smaller, the watchlist updating unit 310 increases the priority degree of the target data by subtracting a predetermined value (for example, 1) from a numerical value in the priority degree information associated with the target data being determined.

### <<Update Processing 2>>

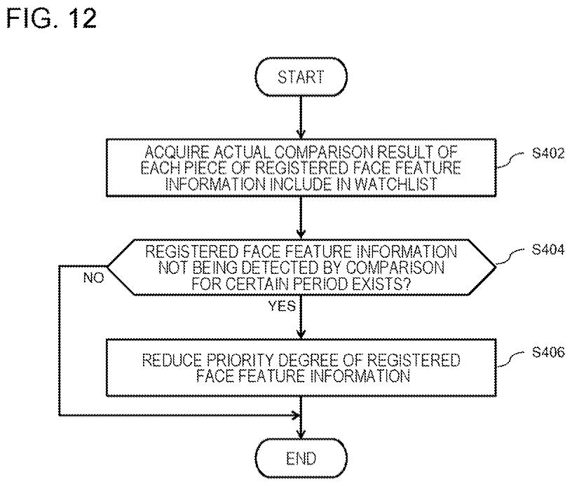

FIG. 12 is a flowchart illustrating one example of the update processing for the priority degree of the registered face feature information. The update processing in the present drawing is processing of changing the priority degree, based on the actual comparison result of each piece of the registered face feature information. For example, the update processing in the present drawing is executed according to a pre-set schedule or an instruction from a user being acquired via the user terminal 50.

For example, a user activates an application program installed in the user terminal 50, and instructs start of change processing for the priority degree in the watchlist via the application. When the instruction is received via the user terminal 50, the watchlist updating unit 310 acquires an actual comparison result (a time period elapsed from initial registration or previous detection by comparison) for each piece of the registered face feature information included in each of the watchlists (S402). In this case, for example, in the watchlist, a field for storing a registration date or a previous detection date by comparison is prepared for each piece of the registered face information. The watchlist updating unit 310 is capable of computing an elapse time period from detection of each piece of the registered face feature information, based on the date stored in the field.

Subsequently, the watchlist updating unit 310 determines whether the registered face feature information not being detected by comparison for a certain period exists, based on the actual comparison result acquired by the processing in S402 (S404). When the registered face feature information not being detected by comparison for a certain period exists (S404: YES), the watchlist updating unit 310 reduces the priority degree of the registered face feature information (S406). For example, when the priority degree becomes higher as the value indicated in the priority degree information is smaller, the watchlist updating unit 310 reduces the priority degree of the target data by adding a predetermined value (for example, 1) to the numerical value in the priority degree information associated with the registered face feature information being relevant.

### <<Update Processing 3>>

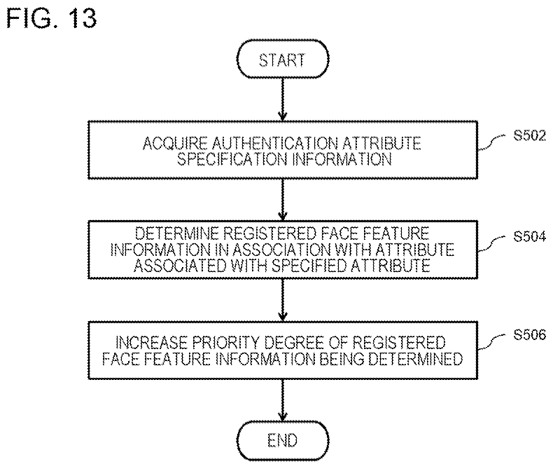

FIG. 13 is a flowchart illustrating one example of the update processing for the priority degree of the registered face feature information. The update processing in the present drawing is processing of changing the priority degree, based on information specifying a target attribute of the face authentication processing. For example, the update processing in the present drawing is executed according to a specification input from a user being executed by using the user terminal 50 or information being automatically input from an external system.

First, the watchlist updating unit 310 acquires information (hereinafter, also referred to as “authentication attribute specification information”) for specifying a target attribute of the face authentication processing (S502). For example, the watchlist updating unit 310 acquires the authentication attribute specification information generated based on a specification input performed by a user with respect to the user terminal 50. Further, the watchlist updating unit 310 may acquires a processing result of an external system, as the authentication attribute specification information. For example, information relating to a predetermined event (information indicating an attribute of a person relating to the event, a classification of the event, an occurrence location of the event, and the like) being detected by an external video surveillance system may be acquired as the authentication attribute specification information. As a specific example, the watchlist updating unit 310 is capable of acquiring, as the authentication attribute specification information, information indicating “20s/male”, information indicating a classification of an ongoing investigation incident or an accident (for example, a classification such as “theft” and “injury”), information indicating an occurrence location of the ongoing investigation incident or the accident, and the like.

The watchlist updating unit 310 determines registered face feature information in association with an attribute associated with an attribute specified by the authentication attribute specification information acquired by the processing in S502, in each of the first watchlist and the second watchlist (S504). For example, it is assumed that the attribute specified by the authentication attribute specification information being acquired is “20s” and “male”. In this case, the watchlist updating unit 310 determines registered face feature information in association with additional information including attributes being “20s” and “male” as “age” and “gender”, respectively, in the first watchlist and the second watchlist. Further, it is assumed that the attribute specified by the authentication attribute specification information is “theft”. In this case, the watchlist updating unit 310 determines registered face feature information in association with the additional information in which “a past behavioral history” includes “theft” or an incident classification similar to “theft” (including snatching, shoplifting, and the like), in the first watchlist and the second watchlist. Further, it is assumed that the attribute specified by the authentication attribute specification information is information indicating a predetermined location (for example, an address or the like). In this case, the watchlist updating unit 310 determines registered face feature information in association with the additional information including, as a “residential area” or a “a birth place”, information relating to a location matching with or in proximity to the location being specified, in the first watchlist and the second watchlist.

Subsequently, the watchlist updating unit 310 increases the priority degree of the registered face feature information determined by the processing in S504 (S506). When a plurality of pieces of registered face feature information are determined by the processing in S504, the watchlist updating unit 310 is capable of increasing the priority degrees of the plurality of pieces of registered face feature information. For example, when the priority degree becomes higher as the value indicated in the priority degree information is smaller, the watchlist updating unit 310 increases the priority degree of the target data by subtracting a predetermined value (for example, 1) from the numerical value in the priority degree information associated with the registered face feature information being determined. Further, the watchlist updating unit 310 may change the numerical value in the priority degree information associated with the registered face feature information being determined, to a minimum value.

<<Update Processing 4>>

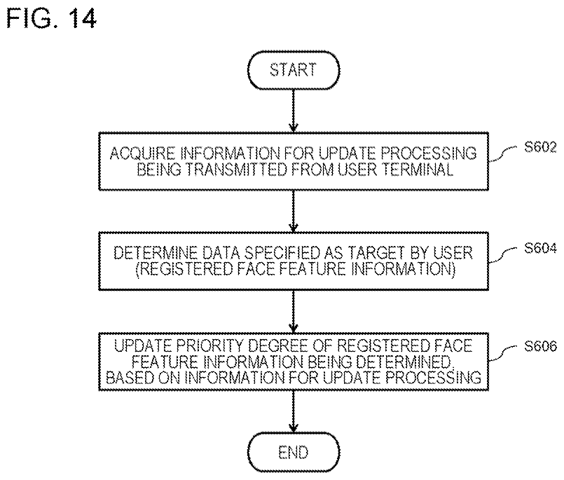

FIG. 14 is a flowchart illustrating one example of the update processing for the priority degree of the registered face feature information. The update processing in the present drawing is processing by which a user changes the priority degree of each piece of the registered face feature information in a freely selective manner. For example, the update processing in the present drawing is executed according to a specification input from a user being executed by using the user terminal 50.

For example, a user activates an application program installed in the user terminal 50, and inputs, in an input form provided by the application, (1) the watchlist being an update target, (2) data being an update target, and (3) an update content. For example, as the update content, a user can input information indicating a change point (addition/change of a face photograph or additional information) from existing information, or information specifying increase/reduction of the priority degree and an increase/reduction amount. The user terminal 50 transmits the information input in the input form to the host server 30 (the watchlist updating unit 310). The watchlist updating unit 310 acquires the information transmitted from the user terminal 50 (S602).

Subsequently, the watchlist updating unit 310 determines the target data, based on the information from the user terminal 50 (S604). For example, the watchlist updating unit 310 is capable of determining data being an update target for the priority degree, according to a combination of the items (1) and (2) described above.

Subsequently, the watchlist updating unit 310 updates the priority degree of the data determined as the update target (S606). For example, when the priority degree becomes higher as the value indicated in the priority degree information is smaller, the watchlist updating unit 310 is capable of increasing the priority degree of the data by subtracting a value associated with the number of change points of the data being determined, from the numerical value in the priority degree information associated with the target data being determined. Further, the watchlist updating unit 310 changes the priority degree of the target data according to the specification by a user, based on the input information from a user (information for specifying increase/reduction of the priority degree and an increase/reduction amount).

### <Update Processing for Watchlist>

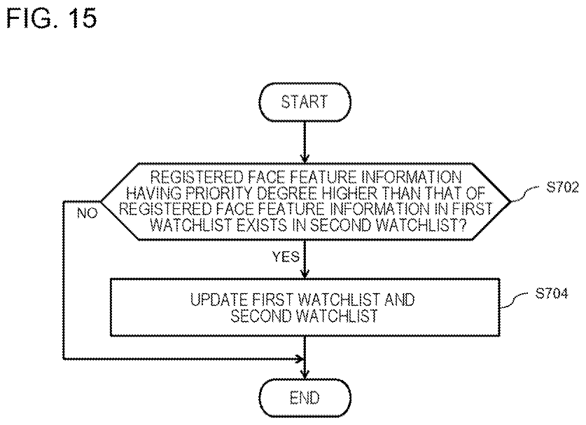

FIG. 15 is a flowchart illustrating the update processing for the watchlist being executed by the watchlist updating unit 310. The processing illustrated in the flowchart in the present drawing is executed at any timing. For example, the processing illustrated in the flowchart in the present drawing may be executed sequentially after the update processing for the priority degree described above. Further, the processing illustrated in the flowchart in the present drawing may be executed according to a schedule being decided in advance (for example, once a day or the like). Processing execution timing in this case may be decided according to the number of pieces of registered face feature information included in the second watchlist (for example, once a day when the number is 100,000, twice a day when the number is 200,000, or the like). Further, the processing illustrated in the flowchart in the present drawing may be executed by an execution instruction from a user via the user terminal 50. The watchlist updating unit 310 determines whether the registered face feature information having a priority degree higher than that of the registered face feature information in the first watchlist exists in the second watchlist (S702). For example, the watchlist updating unit 310 determines the registered face feature information having the lowest priority degree in the first watchlist and the registered face feature information having the highest priority degree in the second watchlist, and compares the priority degrees of those pieces of the registered face feature information.

When the priority degree of the registered face feature information determined in the second watchlist is lower than the priority degree of the registered face feature information determined in the first watchlist (S702: NO), the processing described below is not executed. When the priority degree of the registered face feature information determined in the second watchlist is higher than the priority degree of the registered face feature information determined in the first watchlist (S702: YES), the watchlist updating unit 310 executes update for the first watchlist and the second watchlist (S704). For example, the watchlist updating unit 310 switches the registered face feature information determined in the first watchlist and various types of information associated therewith, and the registered face feature information determined in the second watchlist and various types of information associated therewith.

Note that, the watchlist updating unit 310 may logically switch the information between the first watchlist and the second watchlist by switching a set value of flag information specifying validity/invalidity between the first watchlist and the second watchlist. For example, a case in which registered face feature information (A) having the lowest priority degree in the first watchlist and registered face feature information (B) having the highest priority degree in the second watchlist are switched is examined. In this case, in in the first watchlist, the watchlist updating unit 310 sets “invalidity” to the flag information relating to the registered face feature information (A), and also sets “validity” to the flag information relating to the registered face feature information (B). Further, in the second watchlist, the watchlist updating unit 310 sets “validity” to the flag information relating to the registered face feature information (A), and also sets “invalidity” to the flag information relating to the registered face feature information (B). With this, the registered face feature information (B) is valid in place of the registered face feature information (A) in the first watchlist, and the registered face feature information (A) is valid in place of the registered face feature information (B) in the second watchlist. The number of pieces of information to be switched between the first watchlist and the second watchlist is optional. For example, the watchlist updating unit 310 may repeats the processing illustrated in FIG. 15 until “the lowest value of the priority degree in the first watchlist” becomes greater than “the highest value of the priority degree in the second watchlist”. Further, the watchlist updating unit 310 may repeats the processing illustrated in FIG. 15 up to the number specified by a user (for example, “the top five priority degrees in the second watchlist” or the like) or the number being set based on the number of data included in the second watchlist (for example, “0.01% of the total number” or the like).

Note that, the watchlist updating unit 310 may provide a user with the information being a switching target via the user terminal 50 before the information is switched between the first watchlist and the second watchlist. In this manner, a user can selectively screen the information being a switching target (example: switching all items, not switching all items, or individually selecting information to be switched). In this manner, an effect of improving useability can be expected.

### <Example of Effect>

Both maintenance of authentication accuracy and expansion of an authentication target can be achieved by combining the face authentication processing executed by the first authentication apparatus 10 and the face authentication processing executed by the second authentication apparatus 20 with each other. For example, as described above, a predetermined upper limit value according to accuracy required for the system side is provided to the first watchlist including the registered face feature information relating to a person to be authenticated with priority. With this, accuracy of the face authentication processing using the first watchlist is secured. Further, for a person who is not included in the first watchlist (a person who cannot be authenticated with the first watchlist), occurrence of omission of authentication for the person can be suppressed by the face authentication processing using the second watchlist. Further, an opportunity for authenticating various persons with priority by using the first watchlist can be increased by switching the information as appropriate, based on the priority degree of the registered face feature information included in each of the watchlists. Further, as described in the present example embodiment, the second authentication apparatus 20 executes the authentication processing by utilizing the face feature information not being authenticated by the face authentication processing of the first authentication apparatus 10, instead of newly executing the authentication processing for an image from the image capturing apparatus 40. With this, as compared to a case in which the authentication processing is simply executed twice by using different watchlists, an effect of reducing a total processing load can be acquired.

### Modification Example

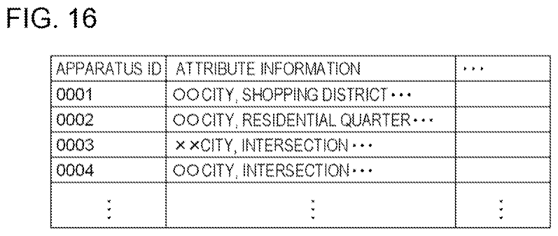

When a plurality of the first authentication apparatuses 10 are included, the face authentication system 1 may be configured in such a way that the watchlists are collectively switched according to an attribute being commonly shared by the plurality of first authentication apparatuses 10. In this case, as a premise, each of the first authentication apparatuses 10 is associated with attribute information indicating an associated attribute. For example, an attribute of each of the first authentication apparatuses 10 is decided based on characteristics (for example, “◯◯ City”, an “intersection”, or the like) of an image capturing location of the image capturing apparatus 40 connected to each of the first authentication apparatuses 10. For example, information indicating a correlation between the first authentication apparatus 10 and the attribute information is stored in advance in a storage region (a memory or a storage of the host server 30) accessible by the watchlist updating unit 310 (example: FIG. 16). FIG. 16 is a diagram illustrating the information indicating the correlation between the first authentication apparatus 10 and the attribute information. In the information illustrated in FIG. 16, an apparatus ID associated with each of the first authentication apparatuses 10 and the attribute information indicating an attribute associated with the first authentication apparatus 10 are stored in association with each other.

In the present modification example, when switching of the watchlists is executed, the watchlist updating unit 310 acquires information (hereinafter, also referred to as “update target information”) indicating an attribute of the first authentication apparatus 10 being an update target. For example, the watchlist updating unit 310 is capable of acquiring the update target information being input from a user via the user terminal 50. Further, for example, when it is decided that switching between a first watchlist and a second watchlist of a certain first authentication apparatus 10 is required in the processing in S702 in the flowchart in FIG. 15, the watchlist updating unit 310 may acquire, as the update target information, attribute information relating to the first authentication apparatus 10 holding the first watchlist, based on the information illustrated in FIG. 16. Further, the watchlist updating unit 310 determines the first authentication apparatus 10 in association with the attribute associated with the attribute indicated in the update target information. For example, in a state in which the information illustrated in FIG. 16 is stored in the storage region, it is assumed that the watchlist updating unit 310 acquires update target information indicating “◯◯ City”. In this case, the watchlist updating unit 310 determines the first authentication apparatus 10 with the apparatus ID being “0001”, the first authentication apparatus 10 with the apparatus ID being “0002”, and the first authentication apparatus 10 with the apparatus ID being “0004” as targets for switching of the watchlists, based on the information illustrated in FIG. 16. Subsequently, the watchlist updating unit 310 executes the switching processing described in FIG. 15 for the first watchlist used in the first authentication apparatus 10 determined based on the update target information. [Second Example Embodiment]

The present example embodiment is similar to the first example embodiment, except for a point described below.

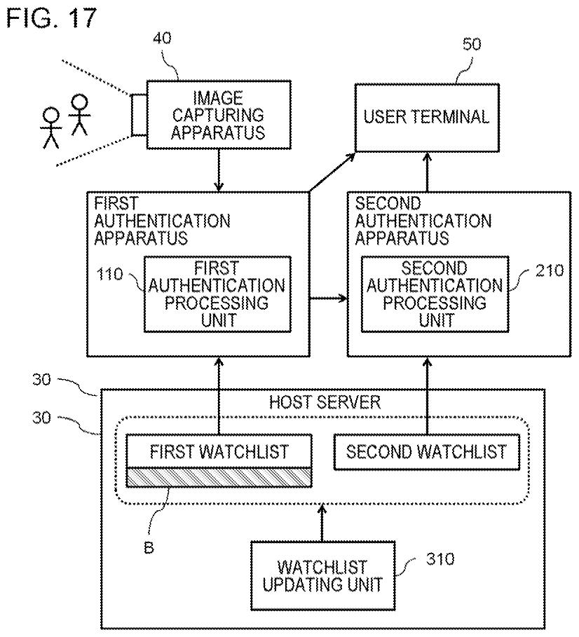

FIG. 17 is a diagram illustrating a configuration of a face authentication system 1 of the second example embodiment. In the present example embodiment, a first watchlist includes a buffer region B for temporarily storing registered face feature information (and various types of information associated with the registered face feature information, such as additional information) being transferred from a second watchlist by switching processing of a watchlist updating unit 310.

For example, a period during which the registered face feature information is stored in the buffer region B may be set by a user in a freely selective manner. For example, when information indicating a certain available period is stored in advance in a storage region (a memory or a storage of a host server 30) accessible by the watchlist updating unit 310, the watchlist updating unit 310 reads the information indicating the available period at a time of transferring from the second watchlist to the first watchlist. Further, for example, when an input for approving switching of the watchlists is performed on a user terminal 50, a user may also perform an input specifying the available period of the registered face feature information transferred from the second watchlist to the first watchlist. The watchlist updating unit 310 stores, in the buffer region B, the acquired information indicating the available period, in association with the registered face feature information transferred from the second watchlist and the first watchlist. For example, in the buffer region B, the registered face feature information transferred from the second watchlist, and the additional information and the information indicating the available period relating to the registered face feature information are stored in association with one another.

In a first authentication apparatus 10, when a first authentication processing unit 110 executes face authentication processing by using the first watchlist, the first authentication processing unit 110 further uses available information based on the “available period” for the registered face feature information stored in the buffer region B.

Further, when one with a set available period being expired is found among pieces of the registered face feature information being temporarily stored in the buffer region B, the watchlist updating unit 310 executes processing of returning the registered face feature information to the second watchlist.

### <Example of Effect>

For example, when a priority degree of a person to be found is changed at timing of occurrence of an incident, the priority degree of the person with an attribute relating to the incident is increased shortly after the occurrence of the incident, but the priority degree may be reduced as time passes. In such a case, a states of the first watchlist and the second watchlist can be updated as appropriate by using the buffer region B described in the present example embodiment, in consideration of a temporal change of the priority degree.

### Third Example Embodiment

In the example embodiments described above, description is made on the flow of updating a content in each of the watchlists, based on a priority degree information for each piece of registered face feature information in a first watchlist and a priority degree information for each piece of registered face feature information in a second watchlist. In the present example embodiment, description is made on a flow of updating a content in each of the watchlists, based on at least one of the priority degree information for each piece of the registered face feature information in the first watchlist and the priority degree information for each piece of the registered face feature information in the second watchlist.

The present example embodiment is similar to the first example embodiment or the second example embodiment, except for a point described below. For example, a face authentication system 1 of the present example embodiment includes a configuration similar to the configuration described in the first example embodiment (example: FIG. 1) or the configuration described in the second example embodiment (example: FIG. 17). Further, each apparatus included in the face authentication system 1 of the present example embodiment includes the hardware configuration illustrated in FIGS. 6 to 8, for example.

In the present example embodiment, any one of the first watchlist and the second watchlist includes priority degree information for each piece of registered face feature information, and the other one does not include the priority degree information for each piece of the registered face feature information. A watchlist updating unit 310 of the present example embodiment updates the registered face feature information in the first watchlist and the second watchlist by using the priority degree information for each piece of the registered face feature information in any one of the first watchlist and the second watchlist. A specific operation example of the watchlist updating unit 310 of the present example embodiment is described later.

<Case in which Priority Degree Information for Each Piece of Registered Face Feature Included in First Watchlist is Used>

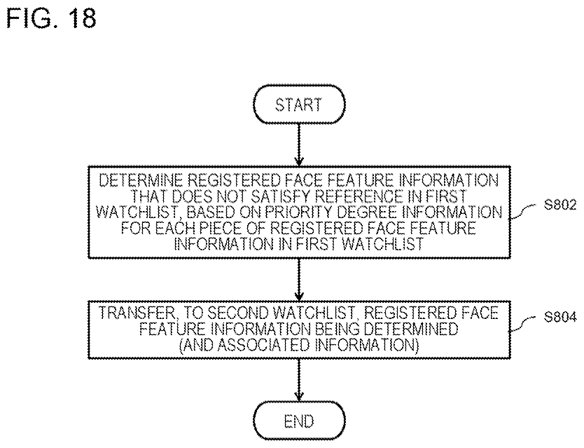

In one example, the watchlist updating unit 310 is configured to update the registered face feature information included in the first watchlist and the registered face feature information included in the second watchlist, based on the priority degree for each piece of the registered face feature information in the first watchlist. The watchlist updating unit 310 performs an operation illustrated in FIG. 18 by using the priority degree information for each piece of the registered face feature information in the first watchlist. FIG. 18 is a flowchart illustrating a flow in which the watchlist updating unit 310 of a third example embodiment transfers the registered face profit information in the first watchlist to the second watchlist.

First, the watchlist updating unit 310 acquires the priority degree information for each piece of the registered face feature information in the first watchlist, and determines registered face feature information with a priority degree that does not satisfy a reference, among pieces of the registered face feature information included in the first watchlist (S802). For example, when the priority degree becomes higher as a value indicated in the priority degree information is smaller, the watchlist updating unit 310 is capable of determining, as “the registered face feature information that does not satisfy the reference”, registered face feature information with a value of associated priority degree information that exceeds a predetermined reference value. Subsequently, the watchlist updating unit 310 transfers, to the second watchlist, the registered face feature information being determined as “the registered face feature information that does not satisfy the reference” and various types of information that are associated with the registered face feature information in the first watchlist (S804). For example, as illustrated in FIGS. 2 to 5, the watchlist updating unit 310 may switch data between the first watchlist and the second watchlist, or may logically switch the data by exclusively switching flag information for switching validity/invalidity of the relevant data in each of the watchlists. Note that, when “the registered face feature information that does not satisfy the reference” is not determined by the processing in S802, the watchlist updating unit 310 does not execute the processing in S804.

In this manner, the watchlist updating unit 310 is capable of updating both the first watchlist and the second watchlist, based on the priority degree for each piece of the registered face feature information in the first watchlist.

Further, in the present example embodiment, the watchlist updating unit 310 may be configured to receive, from a user terminal 50, input information specifying the registered face feature information to be transferred from the first watchlist to the second watchlist. In this case, in addition to the processing illustrated in FIG. 18, the watchlist updating unit 310 determines the registered face feature information from the first watchlist, which is specified by the input information from the user terminal 50, and transfers, to the second watchlist, the registered face feature information being determined and various types of information associated with the registered face feature information.

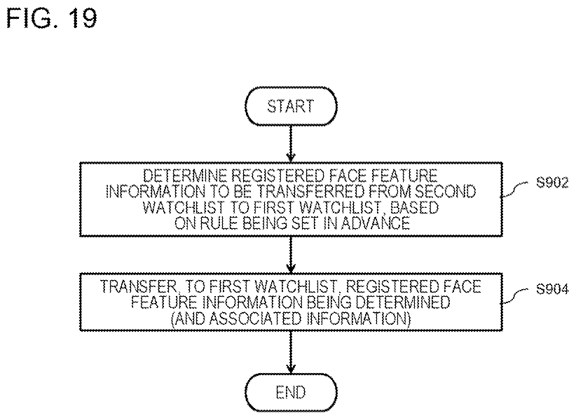

Further, in a case in which only the first watchlist uses the priority degree information for each piece of the registered face feature information, the watchlist updating unit 310 is capable of transferring the registered face feature information included in the second watchlist to the first watchlist, as illustrated in FIG. 19, for example. FIG. 19 is a flowchart illustrating a flow in which the watchlist updating unit 310 of the third example embodiment transfers the registered face profit information in the second watchlist to the first watchlist. First, the watchlist updating unit 310 determines registered face feature information to be transferred to the first watchlist among pieces of the registered face feature information included in the second watchlist, based on a rule being set in advance with respect to the second watchlist (S902). For example, the watchlist updating unit 310 may determine registered face feature information to be transferred from the second watchlist to the first watchlist, based on the number of times (the simple cumulative number of times, the cumulative number of times within a predetermined period (example: within the past 24 hours), or the like) of authentication by authentication processing using the second watchlist. In this case, the watchlist updating unit 310 determines the registered face feature information, which is authenticated by the authentication processing using the second watchlist for the number of times exceeding the predetermined threshold value, as the registered face feature information to be transferred to the first watchlist. Further, for example, when a person associated with certain registered face feature information is authenticated by the authentication processing using the second watchlist, the watchlist updating unit 310 may determine the registered face feature information (the registered face feature information being previously detected) as the registered face feature information to be transferred to the first watchlist. Further, for example, the watchlist updating unit 310 may receive, from the user terminal 50, input information specifying the registered face feature information to be transferred from the second watchlist to the first watchlist, and may determine the registered face feature information being a target, based on the input information. Subsequently, the watchlist updating unit 310 transfers, to the first watchlist, the registered face feature information being determined as “the registered face feature information to be transferred to the first watchlist” in the processing in S902, and various types of information that are associated with the registered face feature information (S904). At this time, for example, the watchlist updating unit 310 associates the priority degree information having a predetermined value with the registered face feature information to be transferred from the second watchlist to the first watchlist. Alternatively, the watchlist updating unit 310 may decide a value of a priority degree associated with the registered face feature information to be transferred from the second watchlist to the first watchlist, according to an actual result (the number of times of authentication or the like) of the authentication processing using the second watchlist.

Herein, as described above, a predetermined upper limit value is possibly provided to the number of registered data in the first watchlist in such a way that a first authentication apparatus 10 maintains accuracy required for the authentication processing executed by using the first watchlist. In the present example embodiment, in some cases, when the registered face feature information is transferred from the second watchlist to the first watchlist, the number of pieces of the registered face feature information included in the first watchlist may exceed the upper limit value. In this case, for example, the watchlist updating unit 310 selects registered face feature information with a lower priority degree in the first watchlist as a switching target, and transfers the registered face profit information being selected to the second watchlist. Further, for example, when the number of pieces of the registered face feature information included in the first watchlist exceeds the predetermined upper limit value, the watchlist updating unit 310 may output, to the user terminal 50, a screen for selecting the registered face feature information to be transferred from the first watchlist to the second watchlist. In this case, the watchlist updating unit 310 is capable of determining the registered face feature information to be transferred from the first watchlist to the second watchlist, based on a selection input by the user terminal 50.

<Case in which Priority Degree Information for Each Piece of Registered Face Feature Included in Second Watchlist is Used>

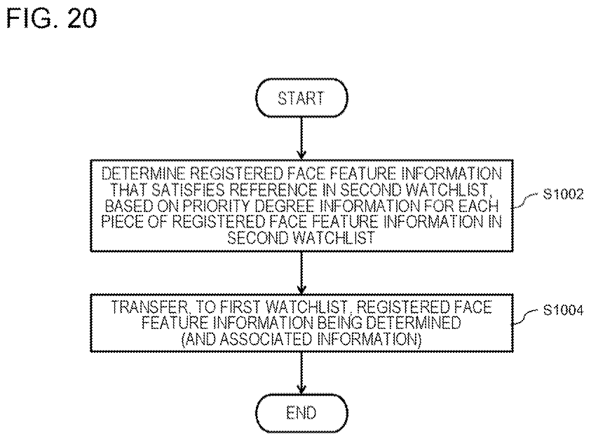

In another example, the watchlist updating unit 310 is configured to update the registered face feature information included in the first watchlist and the registered face feature information included in the second watchlist, based on the priority degree for each piece of the registered face feature information in the second watchlist. The watchlist updating unit 310 performs an operation illustrated in FIG. 20 by using the priority degree information for each piece of the registered face feature information in the second watchlist. FIG. 20 is a flowchart illustrating a flow in which the watchlist updating unit 310 of the third example embodiment transfers the registered face profit information in the second watchlist to the first watchlist.

First, the watchlist updating unit 310 acquires the priority degree information for each piece of the registered face feature information in the second watchlist, and determines registered face feature information with a priority degree that satisfies a reference, among pieces of the registered face feature information included in the second watchlist (S1002). For example, when the priority degree becomes higher as the value indicated in the priority degree information is smaller, the watchlist updating unit 310 is capable of determining, as “the registered face feature information that satisfies the reference”, registered face feature information with a value of associated priority degree information being less than a predetermined reference value.

Subsequently, the watchlist updating unit 310 transfers, to the first watchlist, the registered face feature information being determined as “the registered face feature information that satisfies the reference” and various types of information that are associated with the registered face feature information in the second watchlist (S1004). For example, as illustrated in FIGS. 2 to 5, the watchlist updating unit 310 may switch data between the first watchlist and the second watchlist, or may logically switch the data by exclusively switching the flag information for switching validity/invalidity of the relevant data in each of the watchlists. In this manner, the watchlist updating unit 310 is capable of updating both the first watchlist and the second watchlist, based on the priority degree for each piece of the registered face feature information in the second watchlist.

Further, in the present example embodiment, the watchlist updating unit 310 may be configured to receive, from the user terminal 50, input information specifying the registered face feature information to be transferred from the second watchlist to the first watchlist. In this case, in addition to the processing illustrated in FIG. 20, the watchlist updating unit 310 determines the registered face feature information from the second watchlist, which is specified by the input information from the user terminal 50, and transfers, to the first watchlist, the registered face feature information being determined and various types of information associated with the registered face feature information.

Herein, as described above, a predetermined upper limit value is possibly provided to the number of registered data in the first watchlist in such a way that the first authentication apparatus 10 maintains accuracy required for the authentication processing executed by using the first watchlist. In the present example embodiment, in some cases, when the registered face feature information is transferred from the second watchlist to the first watchlist, the number of pieces of the registered face feature information included in the first watchlist may exceed the upper limit value. In this case, for example, as illustrated in 21, the watchlist updating unit 310 may be configured to determine the registered face feature information to be transferred from the first watchlist to the second watchlist.

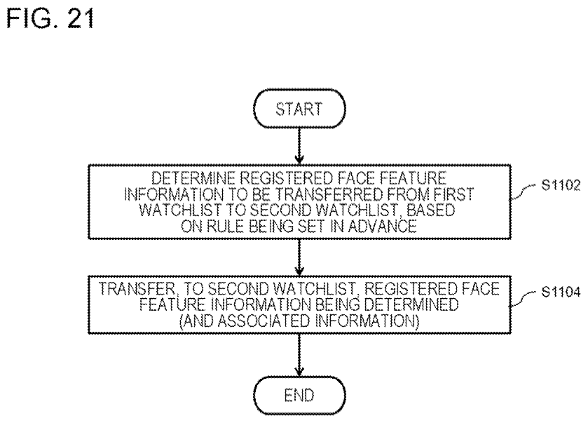

FIG. 21 is a flowchart illustrating a flow in which the watchlist updating unit 310 of the third example embodiment transfers the registered face profit information in the first watchlist to the second watchlist. First, the watchlist updating unit 310 determines registered face feature information to be transferred from the first watchlist to the second watchlist, based on a rule being set in advance with respect to the first watchlist (S1102). For example, the watchlist updating unit 310 may determine registered face feature information to be transferred from the first watchlist to the second watchlist, based on the number of times (the simple cumulative number of times, the cumulative number of times within a predetermined period (example: within the past 24 hours), or the like) of authentication by the authentication processing using the first watchlist. In this case, the watchlist updating unit 310 determines the registered face feature information, which is authenticated by the authentication processing using the first watchlist for the fewest number of times, as the registered face feature information to be transferred to the second watchlist. Further, for example, when each piece of the registered face feature information included in the first watchlist is associated with information indicating a registration date, the watchlist updating unit 310 may determine the registered face feature information with the oldest registration date as the registered face feature information to be transferred to the second watchlist, based on the information. Further, for example, when each piece of the registered face feature information included in the first watchlist is associated with information indicating last authentication date, the watchlist updating unit 310 may determine the registered face feature information with the longest elapse of time since the last detection as the registered face feature information to be transferred to the second watchlist, based on the information. Further, for example, the watchlist updating unit 310 may determine, as the registered face feature information to be transferred from the first watchlist to the second watchlist, based on a combination of a plurality of pieces of information exemplified herein, such as the number of times of authentication, the registration date, and the date of the last authentication. Further, for example, the watchlist updating unit 310 may receive, from the user terminal 50, input information specifying the registered face feature information to be transferred from the first watchlist to the second watchlist, and may determine the registered face feature information being a target, based on the input information.

Subsequently, the watchlist updating unit 310 transfers, to the second watchlist, the registered face feature information being determined as “the registered face feature information to be transferred to the second watchlist” in the processing in S1102, and various types of information that are associated with the registered face feature information (S1104). At this time, for example, the watchlist updating unit 310 associates the priority degree information having a predetermined value with the registered face feature information to be transferred from the first watchlist to the second watchlist. Alternatively, the watchlist updating unit 310 may decide a value of a priority degree associated with the registered face feature information to be transferred from the first watchlist to the second watchlist, according to an actual result (the number of times of authentication or the like) of the authentication processing using the first watchlist. Note that, when “the registered face feature information that satisfies the reference” is not determined by the processing in S1002, the watchlist updating unit 310 does not execute the processing in S1004.

### <Example of Effect>

With the configuration of the present example embodiment, the effects described in the first example embodiment can also be exerted.

While the example embodiments of the present invention are described above with reference to the drawings, the present invention is not limited thereto at the time of interpretation, and various changes, modifications, and the like may be made thereto without departing from the gist of the present invention, based on the knowledge of a person skilled in the art. Further, the plurality of constituent elements disclosed in the example embodiments may be combined with each other as appropriate to form various inventions. For example, some constituent elements may be eliminated from the entire constituent elements indicated in the example embodiments, or the constituent elements of the different example embodiments may be combined with each other as appropriate.

Further, in the plurality of flowcharts used in the description given above, the plurality of steps (pieces of processing) are described in order, but the execution order of the steps executed in each of the example embodiments is not limited to the described order. In each of the example embodiments, the order of the illustrated steps may be changed without interfering with the contents.

The whole or a part of the example embodiments described above can be described as, but not limited to, the following supplementary notes.

1.

A face authentication system including:
a first authentication apparatus that executes authentication of a person captured in an input image by comparing face feature information of the person and being acquired from the input image, with registered face feature information in a first watchlist;
a second authentication apparatus that executes authentication of a person unauthenticated with the first watchlist by comparing face feature information of the face feature information for which matching registered face feature information does not exist in the first watchlist, with registered face feature information in a second watchlist; and
a watchlist updating unit that updates registered face feature information in the first watchlist and registered face feature information in the second watchlist, based on at least one of a priority degree for each piece of registered face feature information in the first watchlist and a priority degree for each piece of registered face feature information in the second watchlist.
   2.

The face authentication system according to supplementary note 1, in which
the watchlist updating unit updates registered face feature information in the first watchlist and registered face feature information in the second watchlist, based on a priority degree for each piece of registered face feature information in the first watchlist and a priority degree for each piece of registered face feature information in the second watchlist.
   3.

The face authentication system according to supplementary note 1 or 2, in which
the first authentication apparatus detects a face region of a person from the input image, and generates the face feature information for each of the face regions being detected.
   4.

The face authentication system according to any one of supplementary notes 1 to 3, in which,
when a plurality of first authentication apparatuses exist, each of a plurality of the first authentication apparatuses is associated with attribute information indicating an associated attribute, and
the watchlist updating unit
   acquires update target information indicating an attribute of the first authentication apparatus being an update target,
   determines the first authentication apparatus in association with attribute information associated with an attribute indicated by the update target information, and
   identifies, as an update target, the first watchlist used in the first authentication apparatus being determined.
      5.

The face authentication system according to any one of supplementary notes 1 to 4, in which
person attribute information indicating an attribute of a corresponding person is associated with each piece of registered face feature information in the first watchlist and the second watchlist, and
the watchlist updating unit
   acquires authentication attribute specification information indicating an attribute of a person subjected to authentication, and
   changes a priority degree of each piece of registered face feature information, based on an attribute indicated by the authentication attribute specification information and the person attribute information in each piece of registered face feature information.
      6.

The face authentication system according to any one of supplementary notes 1 to 5, in which
the watchlist updating unit updates a priority degree of the registered face feature information in each of the first watchlist and the second watchlist, based on an actual comparison result of each piece of the registered face feature information.
   7.

The face authentication system according to any one of supplementary notes 1 to 6, in which
the first watchlist includes a buffer region in which registered face feature information transferred from the second watchlist is stored temporarily.
   8.

A face authentication method including:
by a first authentication apparatus, executing authentication of a person captured in an input image by comparing face feature information of the person being extracted from the input image, with registered face feature information in a first watchlist;
by a second authentication apparatus, executing authentication of a person unauthenticated with the first watchlist by comparing face feature information of the face feature information for which matching registered face feature information does not exist in the first watchlist, with registered face feature information in a second watchlist; and
by a host server, updating registered face feature information in the first watchlist and registered face feature information in the second watchlist, based on at least one of a priority degree for each piece of registered face feature information in the first watchlist and a priority degree for each piece of registered face feature information in the second watchlist.
   9.

The face authentication method according to supplementary note 8, further including,
by the host server, updating registered face feature information in the first watchlist and registered face feature information in the second watchlist, based on a priority degree for each piece of registered face feature information in the first watchlist and a priority degree for each piece of registered face feature information in the second watchlist.
   10.

The face authentication method according to supplementary note 8 or 9, further including,
by the first authentication apparatus, detecting a face region of a person from the input image, and generating the face feature information for each of the face regions being detected.
   11.

The face authentication method according to any one of supplementary notes 8 to 10, in which,
when a plurality of the first authentication apparatuses exist, each of a plurality of the first authentication apparatuses is associated with attribute information indicating an associated attribute,
the face authentication method, further including,
by the host server:
   acquiring update target information indicating an attribute of the first authentication apparatus being an update target;
   determining the first authentication apparatus in association with attribute information associated with an attribute indicated by the update target information; and
   identifying, as an update target, the first watchlist used in the first authentication apparatus being determined.
      12.

The face authentication method according to any one of supplementary notes 8 to 11, in which
person attribute information indicating an attribute of a corresponding person is associated with each piece of registered face feature information in the first watchlist and the second watchlist,
the face authentication method, further including,
by the host server:
   acquiring authentication attribute specification information indicating an attribute of a person subjected to authentication; and
   changing a priority degree of each piece of registered face feature information, based on an attribute indicated by the authentication attribute specification information and the person attribute information in each piece of registered face feature information.
      13.

The face authentication method according to any one of supplementary notes 8 to 12, further including,
by the host server,
   updating a priority degree of the registered face feature information in each of the first watchlist and the second watchlist, based on an actual comparison result of each piece of the registered face feature information.
      14.

The face authentication method according to any one of supplementary notes 8 to 13, in which
the first watchlist includes a buffer region in which registered face feature information transferred from the second watchlist is stored temporarily.
   15.

A program causing a computer to function as:
a watchlist updating unit that updates registered face feature information in a first watchlist and registered face feature information in a second watchlist, based on at least one of a priority degree for each piece of registered face feature information in the first watchlist and a priority degree for each piece of registered face feature information in the second watchlist.
   16.

The program according to supplementary note 15, in which
the watchlist updating unit updates registered face feature information in the first watchlist and registered face feature information in the second watchlist, based on a priority degree for each piece of registered face feature information in the first watchlist and a priority degree for each piece of registered face feature information in the second watchlist.
   17.

The program according to supplementary note 15 or 16, in which,
in a case in which a first authentication apparatus executes authentication of a person captured in an input image by comparing face feature information of the person being acquired from the input image, with registered face feature information in the first watchlist, when a plurality of the first authentication apparatuses exist, each of a plurality of the first authentication apparatuses is associated with attribute information indicating an associated attribute, and
the watchlist updating unit
   acquires update target information indicating an attribute of the first authentication apparatus being an update target,
   determines the first authentication apparatus in association with attribute information associated with an attribute indicated by the update target information, and
   identifies, as an update target, the first watchlist used in the first authentication apparatus being determined.
      18.

The program according to any one of supplementary notes 15 to 17, in which
person attribute information indicating an attribute of a corresponding person is associated with each piece of registered face feature information in the first watchlist and the second watchlist, and
the watchlist updating unit
   acquires authentication attribute specification information indicating an attribute of a person subjected to authentication, and
   changes a priority degree of each piece of registered face feature information, based on an attribute indicated by the authentication attribute specification information and the person attribute information in each piece of registered face feature information.
      19.

The program according to any one of supplementary notes 15 to 18, in which
the watchlist updating unit updates a priority degree of the registered face feature information in each of the first watchlist and the second watchlist, based on an actual comparison result of each piece of the registered face feature information.
   20.

The program according to any one of supplementary notes 15 to 19, in which
the first watchlist includes a buffer region in which registered face feature information transferred from the second watchlist is stored temporarily.

### REFERENCE SIGNS LIST

1 Face authentication system
10 First authentication apparatus
1010 Bus
1020 Processor
1030 Memory
1040 Storage device
1050 Input/output interface
1060 Network interface
110 First authentication processing unit
20 Second authentication apparatus
2020 Processor
2030 Memory
2040 Storage
2040 Storage device
2060 Network interface
210 Second authentication processing unit
30 Host server
3020 Processor
3030 Memory
3040 Storage
3040 Storage device
3060 Network interface
310 Watchlist updating unit
40 Image capturing apparatus
50 User terminal

What is claimed is:

1. A face authentication system comprising:
a first authentication apparatus that executes authentication of a person captured in an input image by comparing face feature information of the person being acquired from the input image, with registered face feature information in a first watchlist;
a second authentication apparatus that executes authentication of a person unauthenticated with the first watchlist by comparing face feature information of the face feature information for which matching registered face feature information does not exist in the first watchlist, with registered face feature information in a second watchlist; and
a host server that updates registered face feature information in the first watchlist and registered face feature information in the second watchlist, based on at least one of a priority degree for each piece of registered face feature information in the first watchlist and a priority degree for each piece of registered face feature information in the second watchlist.

2. The face authentication system according to claim 1, wherein
the host server updates registered face feature information in the first watchlist and registered face feature information in the second watchlist, based on a priority degree for each piece of registered face feature information in the first watchlist and a priority degree for each piece of registered face feature information in the second watchlist.

3. The face authentication system according to claim 1, wherein
the first authentication apparatus detects a face region of a person from the input image, and generates the face feature information for each of the face regions being detected.

4. The face authentication system according to claim 1, wherein,
when a plurality of the first authentication apparatuses exist, each of a plurality of the first authentication apparatuses is associated with attribute information indicating an associated attribute, and
the host server
acquires update target information indicating an attribute of the first authentication apparatus being an update target,
determines the first authentication apparatus in association with attribute information associated with an attribute indicated by the update target information, and
identifies, as an update target, the first watchlist used in the first authentication apparatus being determined.

5. The face authentication system according to claim 1, wherein
person attribute information indicating an attribute of a corresponding person is associated with each piece of registered face feature information in the first watchlist and the second watchlist, and
the host server
acquires authentication attribute specification information indicating an attribute of a person subjected to authentication, and
changes a priority degree of each piece of registered face feature information, based on an attribute indicated by the authentication attribute specification information and the person attribute information in each piece of registered face feature information.

6. The face authentication system according to claim 1, wherein
the host server updates a priority degree of the registered face feature information in each of the first watchlist and the second watchlist, based on an actual comparison result of each piece of the registered face feature information.

7. The face authentication system according to claim 1, wherein
the first watchlist includes a buffer region in which registered face feature information transferred from the second watchlist is stored temporarily.

8. A face authentication method comprising:
by a first authentication apparatus, executing authentication of a person captured in an input image by comparing face feature information of the person being extracted from the input image, with registered face feature information in a first watchlist;
by a second authentication apparatus, executing authentication of a person unauthenticated with the first watchlist by comparing face feature information of the face feature information for which matching registered face feature information does not exist in the first watchlist, with registered face feature information in a second watchlist; and
by a host server, updating registered face feature information in the first watchlist and registered face feature information in the second watchlist, based on at least one of a priority degree for each piece of registered face feature information in the first watchlist and a priority degree for each piece of registered face feature information in the second watchlist.

9. A non-transitory computer-readable medium storing a program for causing a computer to function as: perform operations, the operations comprising
updating registered face feature information in a first watchlist and registered face feature information in a second watchlist, based on at least one of a priority degree for each piece of registered face feature information in the first watchlist and a priority degree for each piece of registered face feature information in the second watchlist.

10. The face authentication method according to claim 8, further including,
by the host server, updating registered face feature information in the first watchlist and registered face feature information in the second watchlist, based on a priority degree for each piece of registered face feature information in the first watchlist and a priority degree for each piece of registered face feature information in the second watchlist.

11. The face authentication method according to claim 8, further including,
by the first authentication apparatus, detecting a face region of a person from the input image, and generating the face feature information for each of the face regions being detected.

12. The face authentication method according to claim 8, wherein,
when a plurality of the first authentication apparatuses exist, each of a plurality of the first authentication apparatuses is associated with attribute information indicating an associated attribute,
the face authentication method, further including,
by the host server:
acquiring update target information indicating an attribute of the first authentication apparatus being an update target;
determining the first authentication apparatus in association with attribute information associated with an attribute indicated by the update target information; and
identifying, as an update target, the first watchlist used in the first authentication apparatus being determined.

13. The face authentication method according to claim 8, wherein
person attribute information indicating an attribute of a corresponding person is associated with each piece of registered face feature information in the first watchlist and the second watchlist,
the face authentication method, further including,
by the host server:
acquiring authentication attribute specification information indicating an attribute of a person subjected to authentication; and
changing a priority degree of each piece of registered face feature information, based on an attribute indicated by the authentication attribute specification information and the person attribute information in each piece of registered face feature information.

14. The face authentication method according to claim 8, further including, by the host server,
updating a priority degree of the registered face feature information in each of the
first watchlist and the second watchlist, based on an actual comparison result of each piece of the registered face feature information.

15. The non-transitory computer-readable medium according to claim 9, wherein
the operations further comprise updating registered face feature information in the first watchlist and registered face feature information in the second watchlist, based on a priority degree for each piece of registered face feature information in the first watchlist and a priority degree for each piece of registered face feature information in the second watchlist.

16. The non-transitory computer-readable medium according to claim 9, wherein,
in a case wherein a first authentication apparatus executes authentication of a person captured in an input image by comparing face feature information of the person being acquired from the input image, with registered face feature information in the first watchlist, when a plurality of the first authentication apparatuses exist, each of a plurality of the first authentication apparatuses is associated with attribute information indicating an associated attribute, and
the operations further comprise
acquiring update target information indicating an attribute of the first authentication apparatus being an update target,
determining the first authentication apparatus in association with attribute information associated with an attribute indicated by the update target information, and
identifying, as an update target, the first watchlist used in the first authentication apparatus being determined.

17. The non-transitory computer-readable medium according to claim 9, wherein
person attribute information indicating an attribute of a corresponding person is associated with each piece of registered face feature information in the first watchlist and the second watchlist, and
the operations further comprise
acquiring authentication attribute specification information indicating an attribute of a person subjected to authentication, and
changing a priority degree of each piece of registered face feature information, based on an attribute indicated by the authentication attribute specification information and the person attribute information in each piece of registered face feature information.

18. The non-transitory computer-readable medium according to claim 9, wherein
the operations further comprise updating a priority degree of the registered face feature information in each of the first watchlist and the second watchlist, based on an actual comparison result of each piece of the registered face feature information.
